(19) United States
(12) Patent Application Publication
(10) Pub. No.: US 2013/0323955 A1
(43) Pub. Date: Dec. 5, 2013

(54) CONNECTOR TERMINAL AND CARD EDGE TYPE CONNECTOR INCLUDING THIS CONNECTOR TERMINAL

(71) Applicants: Akihiro Nishio, Yokkaichi-shi (JP); Hiroki Hirai, Yokkaichi-shi (JP); Kouichi Matsumoto, Yokkaichi-shi (JP); Yasuo Omori, Yokkaichi-shi (JP)

(72) Inventors: Akihiro Nishio, Yokkaichi-shi (JP); Hiroki Hirai, Yokkaichi-shi (JP); Kouichi Matsumoto, Yokkaichi-shi (JP); Yasuo Omori, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/984,682

(22) PCT Filed: Apr. 24, 2012
(86) PCT No.: PCT/JP2012/002793

§ 371 Date: Aug. 9, 2013

(30) Foreign Application Priority Data
May 9, 2011 (JP) 2011-104433

(51) Int. Cl. H01R 12/72

(52) U.S. Cl. CPC H01R 12/721
USPC 439/325

(57) ABSTRACT

A connector terminal includes: a main body section having a board-contacting-surface which is flat and capable of contacting a connecting conductor of a circuit board; and an elastic deforming section that is positioned on a side opposite to the board-contacting-surface in a thickness direction of the circuit board, and that can deform elastically in the thickness direction with respect to the main body section.

### TECHNICAL FIELD

This invention relates to a connector terminal and a card edge type connector including this connector terminal for electrically connecting a connecting conductor formed on a surface of an edge portion of a circuit board, with an electrical wire, or the like.

### BACKGROUND ART

For example, Patent Document 1 discloses a card edge type connector such as that shown in FIG. 8. The connector 90 disclosed in Patent Document 1 includes terminals 92 which are provided respectively at the ends of a plurality of electrical wires 91, and a housing 94 having a board inserting section 95 which holds these terminals 92 and into which a circuit board 100 is inserted. The terminals 92 have elastically displaceable elastic contacting pieces 93. The housing 94 holds the terminals 92 in an arrangement whereby the elastic contacting pieces 93 of the terminals 92 sandwich a circuit board 100 from the front and rear surface sides when the circuit board 100 has been inserted into the board inserting section 95, and the plurality of terminals 92 are aligned in the width direction of the circuit board 100. The elastic contacting pieces 93 of the terminals 92 deform elastically upon making contact with the surface of the circuit board 100 and make pressure contact with the connecting conductors 101 on the surface of the circuit board 100 due to their restoring force.

The elastic contacting pieces 93 of the terminals 92 are formed in a hill shape as shown in FIG. 8, and the peak portions thereof make contact with the connecting conductors 101. Therefore, a wiring contact is made between the terminals 92 and the connecting conductor 101. By forming each elastic contacting piece 93 in a hill shape in this way and causing the peak portion thereof to make contact with a connecting conductor 101, it is possible to make the elastic contacting pieces 93 contact the connecting conductors 101 regardless of the inclination of the elastic contacting pieces 93.

In recent years, size reductions have been achieved in connectors, including card edge type connectors, and higher levels of density are being obtained, which means that terminals are also tending to become smaller. Therefore, in the conventional card edge type connector described above, in which wire contacts are made between terminals and connecting conductors of a circuit board, the contact surface area becomes smaller due to the reduction in the size of the terminals and hence it may become difficult to guarantee connection reliability.

As a way of resolving this problem, it might be possible to use terminals having elastic contacting pieces formed with a flat contact surface, so as to achieve a broad surface contact between each terminal and connecting conductor. However, in this case, there may be situations where the contact surfaces abut against the connecting conductors in a skewed fashion, due to the angle of inclination of the elastic connecting pieces which is caused by bending of the elastic connecting pieces. Tereby, it is difficult ensuring connection reliability.
Patent Document 1: Japanese Patent Application Publication No. 2003-178834

### SUMMARY OF THE INVENTION

The present invention was devised in view of these circumstances, an object thereof being to provide a connector terminal and a card edge type connector whereby good contact can be achieved between a circuit board and a terminals, while ensuring a sufficient contact surface area therebetween.

A connector terminal according to one aspect of the present invention is a connector terminal that is held by a housing into which an edge section of a circuit board provided with a connecting conductor provided on a surface of the edge section is inserted, and that constitutes a card edge type connector together with the housing, wherein the connector terminal includes: a main body section having a board-contacting-surface which is falt and capable of making contact with the connecting conductor of the circuit board; and an elastic deforming section which is positioned on a side opposite to the board-contacting-surface in a thickness direction of the circuit board, and which can deform elastically in the thickness direction with respect to the main body section.

A card edge type connector according to one aspect of the present invention is a card edge type connector which is connected to a circuit board provided with a connecting conductor on a surface of an edge section thereof, the card edge type connector including: the connector terminal described above; and a housing including a board inserting section into which the edge section of the circuit board can be inserted and a terminal accommodating chamber in which the connector terminal is accommodated in such a manner that the main body section is aligned in the thickness direction with respect to the circuit board that is inserted into the board inserting section, and the board-contacting-surface makes contact with the connecting conductor; wherein the connector terminal is accommodated inside the terminal accommodating chamber in such a manner that, when the circuit board is inserted into the board inserting section, the main body section of the connector terminal is displaced towards an inner bottom surface side of the terminal accommodating chamber, with the elastic deforming section being deformed, and the board-contacting-surface of the main body section of the connector terminal makes pressure contact with the connecting conductor due to elastic force generated by the deformation of the elastic deforming section.

### BRIEF DESCRIPTION OF THE DRAWINGS

FIG. 1 is a plan view of an assembled state of an electronic circuit unit which employs a card edge type connector relating to one embodiment of the present invention.

FIG. 2 is a cross-sectional diagram of an assembled state of the electronic circuit unit.

FIG. 3 is a perspective cross-sectional diagram of a disassembled state of the electronic circuit unit.

FIG. 4 is a cross-sectional diagram of a terminal.

FIG. 5 is a cross-sectional diagram of a terminal (a cross-sectional diagram along V-V in FIG. 4).

FIG. 6 is a principal cross-sectional diagram of a first connector before inserting a circuit board.

FIG. 7 is a principal cross-sectional diagram of a first connector after inserting a circuit board.

FIG. 8 is a cross-sectional diagram showing one example of a conventional card edge type connector.

### MODES FOR CARRYING OUT THE INVENTION

Below, embodiments of the present invention are described with reference to the drawings.

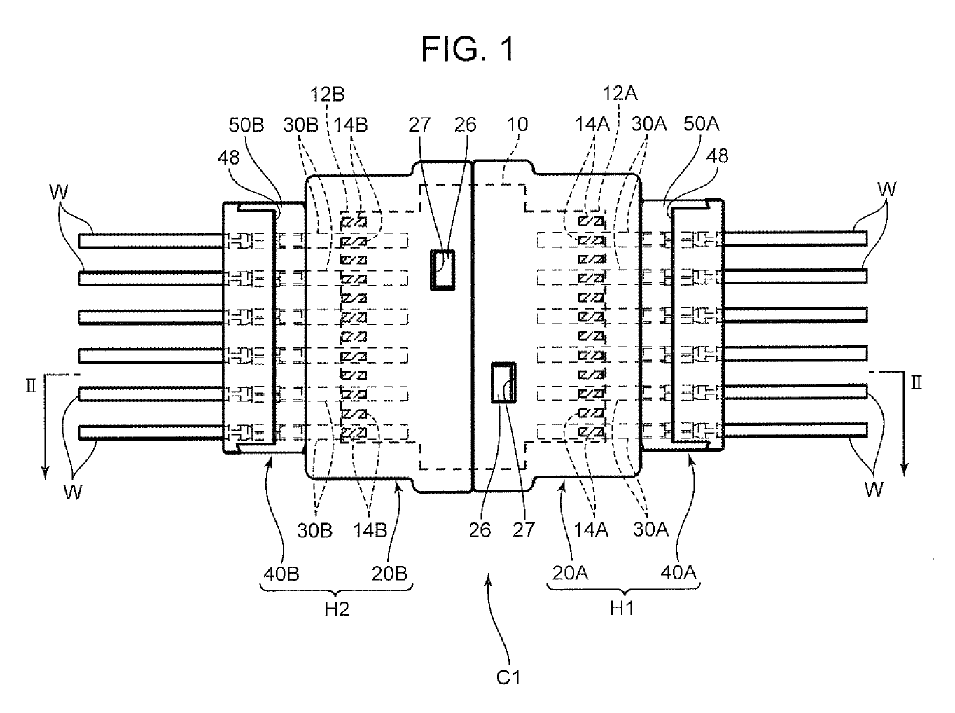

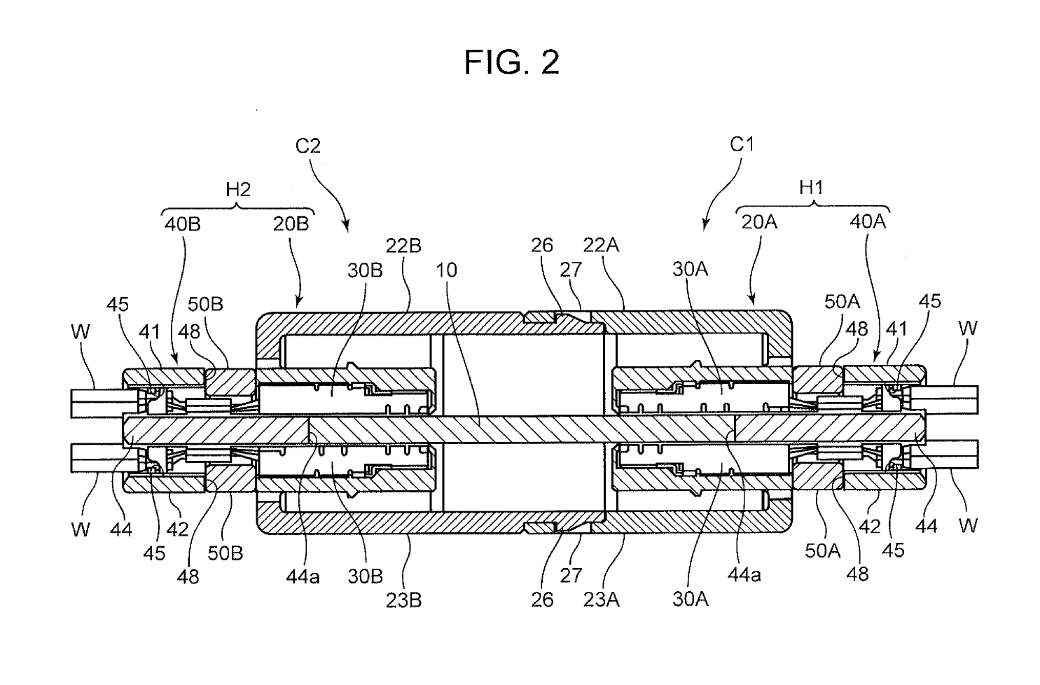

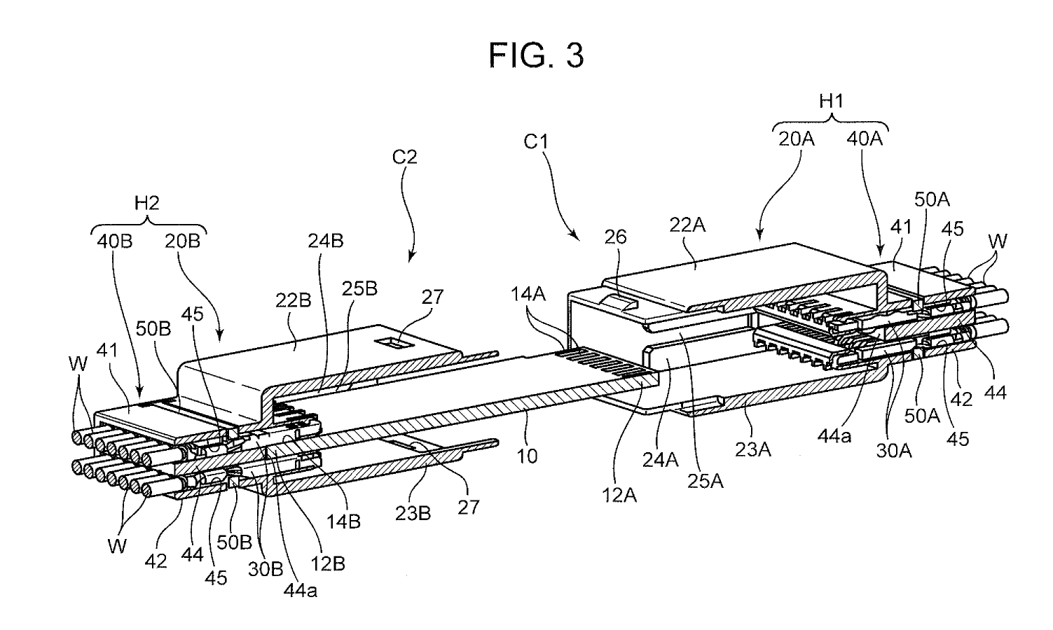

FIG. 1 to FIG. 3 show a schematic view of an electronic circuit unit in which a card edge type connector relating to the present invention is employed. FIG. 1, FIG. 2 and FIG. 3 respectively show the electronic circuit unit in a plan diagram of an upright state, a cross-sectional diagram of an assembled state and a perspective cross-sectional diagram of a disassembled state.

The electronic circuit unit relating to this embodiment includes a circuit board 10, and a first connector C1 and a second connector C2 for connecting a plurality of electrical wires W to the circuit board 10.

The circuit board 10 is a printed circuit board, for example, and a conductor pattern for circuit composition is arranged on both the front and rear surfaces of the circuit board, in addition to which electronic components constituting a circuit are also mounted on the circuit board. The circuit board 10 relating to this embodiment has a rectangular shape. A plurality of thin plate-shaped first connecting conductors 14A are provided on a front surface and a rear surface of a first edge section 12A on one side of a specific direction (on the right-side edge section in FIG. 1 and FIG. 2) and a plurality of thin plate-shaped first connecting conductors 14A and second connecting conductors 14B are provided respectively on a front surface and a rear surface of a second edge section 12B on another side of the specific direction (on the left-side edge section in FIG. 1 and FIG. 2). These connecting conductors 14A, 14B are arranged along the edge sections 12A, 12B.

The first connector C1 and the second connector C2 are so-called card edge type connectors, and the first connector C1 is connected to the first edge section 12A side of the circuit board 10 and the second connector C2 is connected to the second edge section 12B side thereof.

The first connector C1 includes a first housing H1 which is made from an insulating material, such as plastic, and first terminals 30A which are installed respectively on the ends of electrical wires W and which are held by the first housing H1. Similarly, the second connector C2 includes a second housing H2 which is made from an insulating material, and second terminals 30B which are installed respectively on the ends of electrical wires W and which are held by the second housing H2. The first housing H1 and the second housing H2 form a pair and as described hereinafter, are ultimately united with each other, whereby the circuit board 10 is covered from the outside by the housings H1, H2.

The first housing H1 has a first board holding section 20A and a first terminal holding section 40A and the second housing H2 has a second board holding section 20B and a second terminal holding section 40B.

The board holding sections 20A, 20B of the housings H1, H2 are respectively open in a specific direction and have a shape which permits a half portion of the circuit board 10 to be inserted in a board insertion direction that is perpendicular to the board thickness direction. More specifically, as shown in FIG. 2, the first board holding section 20A receives the right half portion of the circuit board 10 (the half portion on the side of the first edge section 12A) and the second board holding section 20B receives the left half portion of the circuit board 10 (the half portion of the side of the second edge section 12B).

The first board holding section 20A of the first housing H1 has a ceiling wall 22A, a bottom wall 23A and a pair of left and right side walls 24A. Similarly, the second board holding section 20B of the second housing H2 has a ceiling wall 22B, a bottom wall 23B and a pair of left and right side walls 24B. The ceiling walls 22A, 22B, and the bottom walls 23A, 23B are arranged in upper and lower positions so as to be mutually parallel. The two side walls 24A are disposed between the ceiling wall 22A and the bottom wall 23A and form a quadrilateral cylinder shape with the ceiling wall 22A and the bottom wall 23A. Similarly, the two side walls 24B are disposed between the ceiling wall 22B and the bottom wall 23B and form a quadrilateral cylinder shape with the ceiling wall 22B and the bottom wall 23B.

As shown in FIG. 1 to FIG. 3, coupling projections 26 and coupling holes 27 are provided respectively in a left/right arrangement on the upper and lower edge portions of the open sides of the board holding sections 20A, 20B of the housings H1, H2, the coupling projections 26 projecting outwards from the edge portions and the coupling holes 27 passing through the edge portions in the thickness direction. The coupling projections 26 of the first board holding section 20A have a shape whereby they can be fitted into and coupled with the board holding section coupling holes 27 of the second board holding section 20B, and the coupling projections 26 of the second board holding section 20B have a shape whereby they can be fitted into and coupled with the board holding section coupling holes 27 of the first board section 20A. By respective coupling of the coupling projections 26 and coupling holes 27 of the first board holding section 20A and the coupling holes 27 and coupling projections 26 of the second board holding section 20B, the two housings H1, H2 assume a united state in which the board holding sections 20A, 20B are mutually abutting (see FIG. 1 and FIG. 2).

Guide grooves 25A are formed respectively at mutually the same height position, on the inner surfaces of side walls 24A of the board holding section 20A. Similarly, guide grooves 25B are formed respectively at mutually the same height position, on the inner surfaces of side walls 24B of the board holding section 20B. The guide grooves 25A, 25B are positioned at mutually the same height position extending in the board insertion direction, and have a width which allows the left and right edge portions of the circuit board 10 to be inserted into the guide grooves 25A, 25B. With this inserting action, the circuit board 10 is introduced into the board holding sections 20A, 20B, whereby the left and right edge portions of the circuit board 10 assume a state of being held from the front and rear sides (from the upper and lower sides in the present embodiment) by the side walls 24A, 24B, in other words, a state of being gripped from either side in the thickness direction of the circuit board 10.

The first terminals 30A and the second terminals 30B are respectively installed on the ends of electrical wires W. The electrical wires W each consist of a conductor (not illustrated) and an insulating covering which covers the conductor. At the end of each electrical wire W, the insulating covering is partially removed so as to expose the conductor.

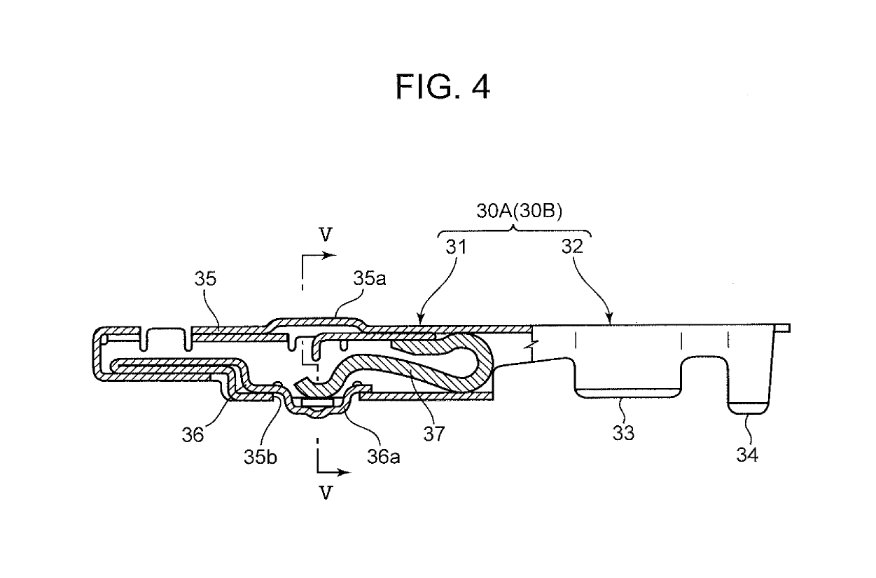

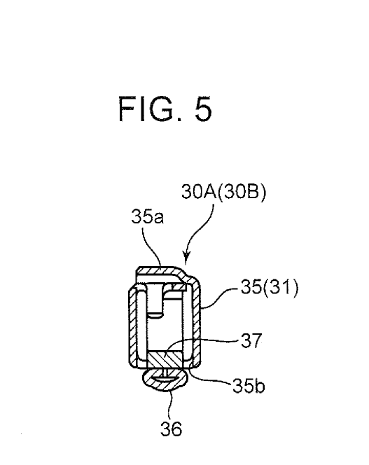

The terminals 30A, 30B are made from metal plate, which is a conductor, and are installed on the ends of corresponding electrical wires W. More specifically, as shown in FIG. 4 and FIG. 5, the terminals 30A, 30B each have a board contacting section 31 and an electrical wire connecting section 32, disposed in a front/rear arrangement. The electrical wire connecting section 32 has a pair of conductor barrels 33 and a pair of insulation barrels 34, disposed in a front/rear arrangement. The pair of conductor barrels 33 are pressure fitted onto the conductor so as embrace the conductor which is exposed at the end of the electrical wire W, thereby the conductor barrels 33 and the conductor are electrically connected. The pair of insulation barrels 34 are pressure fitted onto the electrical wire W so as to embrace the portion of the insulation covering which is positioned slightly to the rear of the exposed portion of the conductor.

The board contacting section 31 includes a main body section 35, an elastic pressing piece 36 (corresponding to the elastic deformation section of the present invention) and an elastic force reinforcing member 37.

The main body section 35 is formed in an integrated fashion with the electrical wire connecting section 32, and a portion of the metal plate constituting the electrical wire connecting section 32 is formed in a square cylindrical shape. A contacting projecting section 35a which protrudes outwards is formed on one of the four walls which constitute the main body section 35, and an aperture 35b is formed in a wall opposing the wall where the contacting projecting section 35a is farmed, at a position opposing the contacting projection section 35a, so as to pass through the opposing wall.

The contacting projecting section 35a is a contact point with respect to the connecting conductors 14A, 14B, and a flat contacting surface (corresponding to the board-contacting-surface of the present invention) having a surface area equal to or similar to the connecting conductors 14A, 14B is provided on an outer side of the contacting projection section 35a. In other words, the terminals 30A, 30B have a shape capable of making surface contact with the whole area or nearly the whole area of the connecting conductors 14A, 14B, via the contacting surface of the contacting projecting section 35a.

The elastic pressing piece 36 is formed by a metal plate connected to a main body section 35, extends in an axial direction (right/left direction in FIG. 4) from the front end of the terminal 30, and has a pressing end section 36a (the contacting section of the present invention) at an end thereof. As shown in FIG. 4 and FIG. 5, the elastic pressing piece 36 can be bent and displaced between a state where the pressing end section 36a is projecting to the outside of the main body section 35 via the aperture 35b and a state where the pressing end section 36a is sunken inside the aperture 35a, and when the elastic pressing piece 36 is not receiving external force, the pressing end section 36a projects to the outside of the main body section 35 through the aperture 35b. Consequently, the pressing end section 36a and the contacting projecting section 35a are disposed in the same position in the axial direction of the terminal.

The elastic force reinforcing member 37 is provided inside the main body section 35 in such a manner the elastic force reinforcing member 37 itself performs elastic deformation as the pressing end section 36a is displaced by the twisting deformation of the elastic pressing piece 36. The elastic reverting force of the elastic pressing piece 36 is increased by the elastic force produced by this elastic deformation.

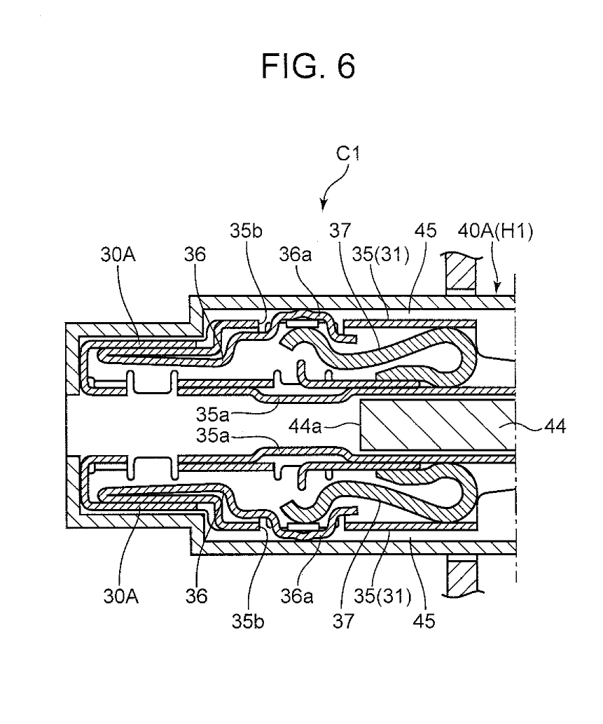

As shown in FIG. 2, FIG. 3 and FIG. 6, the first terminal holding section 40A of the first housing H1 is positioned on the opposite side of the first board holding section 20A from the opening, and is formed in an integrated fashion with the first board holding section 20A. The first terminal holding section 40A gathers and holds the first terminals 30A in an arrangement whereby the contacting projecting sections 35a of the first terminals 30A respectively make contact simultaneously with the first connecting conductors 14A on both surfaces of the first edge section 12A of the circuit board 10. Similarly, the second terminal holding section 40B of the second housing H2 is positioned on the opposite side of the second board holding section 20B from the opening, and is formed in an integrated fashion with the second board holding section 20B. The second terminal holding section 40B gathers and holds the second terminals 30B in an arrangement whereby the contacting projecting sections 35a of the second terminals 30B respectively make contact simultaneously with the second connecting conductors 14B on both surfaces of the second edge section 12B of the circuit board 10.

More specifically, the terminal holding sections 40A, 40B each respectively have an upper and lower pair of walls constituted by a ceiling wall 41 and a bottom wall 42 extending mutually in parallel, an intermediate wall 44 positioned between the ceiling wall 41 and the bottom wall 42, and a left and right pair of side walls (not labeled with reference symbols); a plurality of terminal accommodating chambers 45 aligned in the left/right direction are formed respectively between the ceiling wall 41 and the intermediate wall 44, and between the bottom wall 42 and the intermediate wall 44. The terminal accommodating chambers 45 have a shape whereby the corresponding terminals 30A, 30B are inserted therein from the outside of the housings H1, H2 towards the inside (in FIG. 2 and FIG. 3, from right to left in the case of the first terminal holding section 40A and from left to right in the case of the second terminal holding section 40B), and permit the contacting projecting sections 35a and the elastic pressing pieces 36 to be surrounded inside the board holding sections 20A, 20B.

The respective intermediate walls 44 are situated at the same height position in the guide grooves 25A, 25B. The front ends 44a of the intermediate walls 44 (the left end in the first terminal holding section 40A and the right end in the second terminal holding section 40B in FIG. 3) are positioned to the rear of the front ends of the ceiling wall 41 and the bottom wall 42, and a board insertion space (corresponding to a board insertion section of the present invention) into which the edge sections 12A, 12B of the circuit board 10 can be inserted is ensured respectively on the front side of the front end 44a of each intermediate wall 44. The terminals 30A, 30B are respectively held on the terminal holding sections 40A, 40B in a state where the contacting projecting sections 35a of the terminals 30A, 30B border the board insertion spaces and the pressing end sections 36a of the elastic pressing pieces 36 make contact with the inner bottom surfaces of the terminal accommodating chambers 45.

In other words, the terminals 30A, 30B which are accommodated in the terminal accommodating chambers 45 between the ceiling wall 41 and the intermediate wall 44 (the terminals 30A, 30B in the upper-side row) are held by the terminal holding sections 40A, 40B in such a manner the contacting projecting sections 35a are facing downwards, and the terminals 30A, 30B which are accommodated in the terminal accommodating chambers 45 between the bottom wall 42 and the intermediate wall 44 (the terminals 30A, 30B in the lower-side row) are held by the terminal holding sections 40A, 40B in such a manner the contacting projecting sections 35a are facing upwards. Therefore, the intermediate wall 44 is interposed between an upper-side group of terminals 30A, 30B and a lower-side group of terminals 30A, 30B.

The dimensions of the housings H1, H2 are set in such a manner the edge sections 12A, 12B of the circuit board 10 are inserted completely into the respective board insertion spaces and the end faces of the edge portions 12A, 12B abut against the front ends 44a of the intermediate walls 44, when the first housing H1 and the second housing H2 are united, and the holding positions of the terminals 30A, 30B in the respective terminal holding sections 40A, 40B are set in such a manner that, in this case, the contacting projecting sections 35a of the terminals 30A, 30B make contact simultaneously with the connecting conductors 14A, 14B of the circuit board 10.

The terminal holding sections 40A, 40B respectively have a plurality of lance portions (not illustrated) for engaging the terminals 30A, 30B inside each terminal accommodating chamber 45, and furthermore, retainers 50A, 50B for double-engaging the terminals 30A, 30B (engaging with the terminals in addition to the engagement of the lance portions) are provided additionally in each of the terminal holding sections 40A, 40B.

The retainers 50A, 50B are installed respectively on the ceiling walls 41 and the bottom walls 42 of the terminal holding sections 40. As shown in FIG. 3, the retainers 50A, 50B have a substantially square bar shape extending in a direction parallel to the direction of arrangement of the terminals 30A, 30B.

On the other hand, retainer installation holes 48 are formed respectively in the ceiling walls 41 and the bottom walls 42 of the terminal holding sections 40A, 40B, and have a shape so as to pass through the respective walls in the thickness direction thereof and to traverse same in the width direction. By respectively fitting the retainers 50A, 50B into the retainer installation holes 48 from the outside, in a state where the terminals 30A, 30B have been inserted into the terminal accommodating chambers 45, the retainers 50A, 50B are positioned to the rear of the board contacting sections 31 of the terminals 30A, 30B and prevent removal thereof.

Next, the assembly procedure of this electronic circuit unit will be described.

1) Insertion and Engagement of Terminals 30A, 30B into the Housings H1, H2

When the retainers 50A, 50B have been fitted into the retainer installation holes 48 of the terminal holding sections 40A, 40B and are located in prescribed provisional engaging positions, the terminals 30A, 30B are inserted from the outside to the inside of the housings H1, H2 and into the terminal accommodating chambers 45 of the terminal holding sections 40A, 40B. The lance portions in the terminal holding sections 40A, 40B couple with the inserted terminals 30A, 30B, thereby engaging the terminals 30A, 30B (primary engagement). Consequently, the terminals 30A, 30B are arranged in two rows, an upper and lower row, and the terminals 30A, 30B are held inside the terminal holding sections 40A, 40B with the contacting projecting sections 35a of the upper and lower terminals 30A (30B) facing inwards.

Thereupon, the retainers 50A, 50B are pushed further from this provisional engagement position to a full engagement position inside the terminal holding sections 40A, 40B. Thereby, the retainers 50A, 50B respectively become double-engaged with the terminals 30.

2) Connection between Circuit Board 10 and First Connector C1

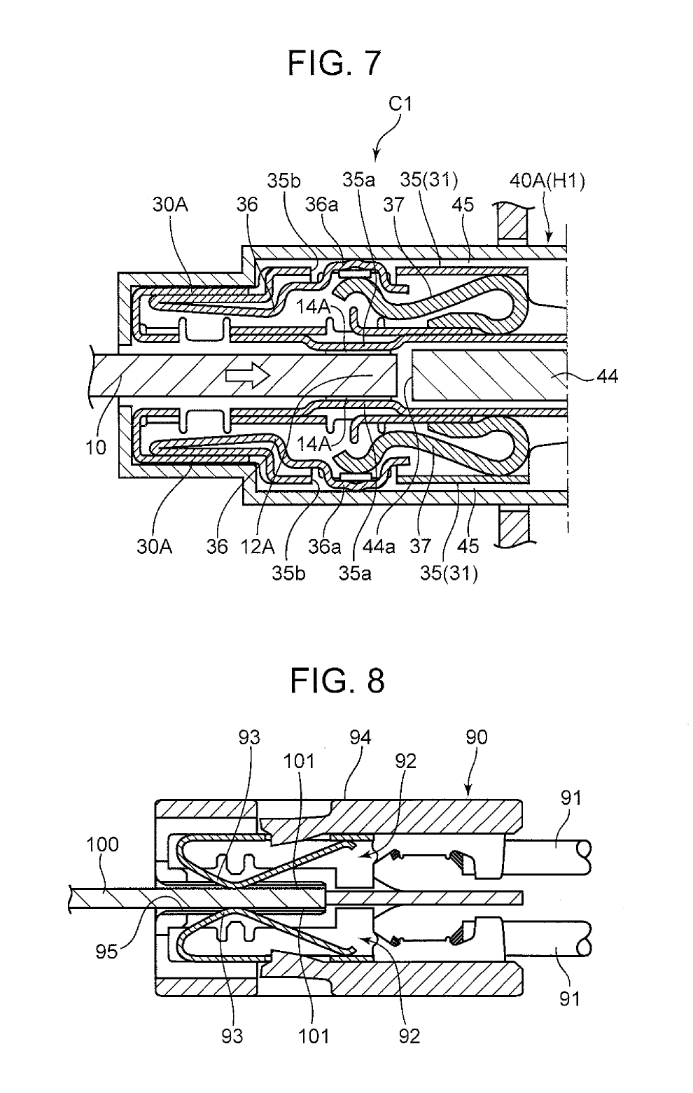

The circuit board 10 is inserted, with the first edge section 12A in a leading position, into the first board holding section 20A of the first housing H1, via the opening of the housing H1. More specifically, the circuit board 10 is inserted accurately along the board insertion direction while being guided by the guide grooves 25A of the side walls 24A on the first board holding section 20A, and the first edge section 12A at the leading end of the circuit board 10 reaches a position abutting the front end 44a of the intermediate wall 44 of the first terminal holding section 40A. Thereby, a state is achieved in which the first connecting conductors 14A provided on both surfaces of the first edge section 12A make contact simultaneously with the contacting projecting sections 35a of the first terminals 30A. In this way, when the circuit board 10 is inserted into the first board holding section 20A, the main body sections 35 of the terminals 30A in the upper row are pressed and squashed to the upper side and the main body sections 35 of the terminals 30A in the lower row are pressed and squashed to the lower side. Consequently, as shown in FIG. 7, the elastic pressing pieces 36 bend and deform such that the pressing end sections 36a become sunken inside the apertures 37a, and due to the elastic force thereof, the main body sections 35 are pushed towards the circuit board 10 and the contacting projecting sections 35a make pressure contact with the first connecting conductors 14A. As a result of this, in the first terminals 30A, the contacting surfaces of the contacting projecting sections 35a make contact with the whole area of the connecting conductors 14A of the circuit board 10, or the area similar thereto.

3) Connection of the Circuit Board 10 and the Second Connector C2 and Uniting of the Housings

Similarly to the description give above, the circuit board 10 is inserted with the second edge section 12B thereof in a leading position, into the second board holding section 20B of the second housing H2. Although not shown in the drawings, in this case also, the main body sections 35 of the terminals 30B in the upper row are pressed and squashed to the upper side and the main body sections 35 of the terminals 30B in the lower row are pressed and squashed to the lower side. Consequently, the elastic pressing pieces 36 bend and deform such that the pressing end sections 36 become sunken inside the apertures 37a, and due to the elastic force thereof, the main body sections 35 are pushed towards the circuit board 10 and the contacting projecting sections 35a make pressure contact with the second connecting conductors 14B. As a result of this, in the second terminals 30B, the contacting surfaces of the contacting projecting sections 35a make contact with the whole area of the connecting conductors 14B of the circuit board 10, or the area similar thereto.

Therefore, the housings H1, H2 become united as the second edge section 12B is inserted into the second board holding section 20B. This united state is maintained by the coupling between the coupling projections 26 and the coupling holes 27 of the first housing H1 and the coupling holes 27 and the coupling projections 26 of the second housing H2.

As described above, in the connectors C1, C2 which are employed in the electronic circuit unit described above, when the circuit board 10 is inserted into the housings H1, H2, the contacting projecting sections 35a formed on the board contacting sections 31 of the terminals 30A, 30B make contact with the connecting conductors 14A, 14B of the circuit board 10. In this case, the elastic pressing pieces 36 deform elastically and the main body sections 35 of the board contacting sections 31 are pressed towards the circuit board 10 by the elastic force of the elastic pressing pieces 36, whereby the whole of the contact surfaces of the contacting projecting sections 35a make stable contact with the connecting conductors 14A, 14B of the circuit board 10. In other words, since contacting projecting sections 35a are provided on the main body sections 35, then the elastic pressing pieces 36 provided on the opposite side from the contacting projecting sections 35a deform elastically and press the contacting projecting sections 35a against the connecting conductors 14A, 14B. Therefore, it is possible to cause the whole of the contact surfaces of the contacting projecting sections 35a to make stable contact with the connecting conductors 14A, 14B, regardless of the bending angle, and the like, of the elastic pressing pieces 36. Consequently, by these connectors C1, C2, it is possible to ensure a sufficient contact surface area between the circuit board 10 and the terminals 30A, 30B, and to create good contact therebetween, whereby the connection reliability between the circuit board 10 and the connectors C1, C2 is improved.

In particular, in the terminals 30A, 30B, since the pressing end sections 36a of the elastic pressing pieces 36 are disposed at the same position as the contacting projecting sections 35a (contact surfaces), in the axial direction of the terminals, and are formed so as to be aligned in the thickness direction of the circuit board 10, then the contacting projecting sections 35a are pressed upwards and downwards in a stable fashion again the circuit board 10. Therefore, it is possible to cause the connecting conductors 14A, 14B of the circuit board 10 to make contact more stably with the whole contact surface of the contacting projecting sections 35a.

Furthermore, the terminals 30A, 30B have elastic force reinforcing members 37 which increase the elastic restoring force of the elastic pressing pieces 36, and therefore compared to the elastic pressing pieces 36 alone, the main body sections 35 of the terminals 30A, 30B can be pressed more strongly against the circuit board 10, whereby the whole contact surface of the contacting projecting sections 35a can be made to contact the connecting conductors 14A, 14B more reliably.

The connectors C1, C2 and the terminals 30A, 30B used in the electronic circuit unit described above are one embodiment of a connector terminal and a card edge type connector including same according to the present invention, and the specific composition of the terminals 30A, 30B and the connectors C1, C2 can be modified appropriately within a range that does not deviate from the essence of the present invention.

A summary of the present invention described above is given below.

A connector terminal according to one aspect of the present invention is a connector terminal which is held by a housing into which an edge section of a circuit board provided with a connecting conductor provided on a surface of the edge section is inserted, and which constitutes a card edge type connector together with the housing, wherein the connector terminal includes: a main body section having a board-contacting-surface which is falt and capable of making contact with the connecting conductor of the circuit board; and an elastic deforming section which is positioned on an opposite side from the board-contacting-surface in a thickness direction of the circuit board, and which deforms elastically in the thickness direction with respect to the main body section.

A card edge type connector according to one aspect of the present invention is a card edge type connector which is connected to a circuit board provided with a connecting conductor on a surface of an edge section thereof, the card edge type connector including: the connector terminal described above; and a housing including a board inserting section into which the edge section of the circuit board can be inserted and a terminal accommodating chamber in which the connector terminal is accommodated in such a manner that the main body section is aligned in the thickness direction with respect to the circuit board that is inserted into the board inserting section, and the board-contacting-surface makes contact with the connecting conductor; wherein the connector terminal is accommodated inside the terminal accommodating chamber in such a manner that, when the circuit board is inserted into the board inserting section, the main body section of the connector terminal is displaced towards an inner bottom surface side of the terminal accommodating chamber, with the elastic deforming section being deformed, and the board-contacting-surface of the main body section of the connector terminal makes pressure contact with the connecting conductor due to elastic force generated by the deformation of the elastic deforming section.

In this card edge type connector, when the circuit board is inserted into the housing (board inserting section), a flat board-contacting-surface provided on a main body section of the connector terminal makes contact with the connecting conductor of the circuit board, whereby the connector terminal and the connecting conductor are electrically connected. In so doing, the elastic deforming section of the connector terminal deforms elastically, and the whole of the main body section makes pressure contact with the circuit board due to this elastic force. In other words, since a board-contacting-surface is provided on the main body section, and the board-contacting-surface makes pressure contact with the connecting conductor by elastic deformation of the elastic contacting piece which is provided on the opposite side to the board-contacting-surface, then the whole of the board-contacting-surface can be made to contact the connecting conductor stably, regardless of the bending angle, or the like, of the elastic deforming section. Consequently, it is also possible to ensure good contact between the circuit board and the connector terminal while ensuring a suitable contact surface area therebetween.

In this card edge type connector, desirably, the elastic deforming section of the connector terminal has an abutting section which abuts against the inner bottom surface of the terminal accommodating chamber and receives a reactive force from the inner bottom surface; and the board-contacting-surface and the abutting section of the connector terminal are aligned in the thickness direction of the circuit board.

According to this composition, it is possible to press the board-contacting-surface against the circuit board more reliably in the thickness direction of the circuit board.

Furthermore, desirably, the connector terminal further includes an elastic force reinforcing section which increases the elastic force of the elastic deforming section by deforming elastically together with the elastic deforming section with respect to the main body section.

According to this composition, since the main body section of the connector terminal can be pressed more strongly against the circuit board, then it is possible to cause the board-contacting-surface to make tight contact more reliably with the connecting conductor.

The card edge type connector may include a plurality of connector terminals as the connector terminal, in which case, desirably, the housing holds the plurality of connector terminals in such a manner that the connector terminals are respectively positioned on both the front and rear surfaces of the circuit board which is inserted into the board inserting section and the connector terminals are aligned in a direction along the edge section of the circuit board.

According to this composition, it is possible to cause a plurality of connector terminals to make contact with connecting conductors of a circuit board, efficiently, while ensuring a sufficient contact surface area between the circuit board and the connector terminals.

### INDUSTRIAL APPLICABILITY

As described above, the connector terminal or the card edge type connector including this connector terminal according to the present invention can create good contact between a circuit board and a connector terminal, while ensuring a sufficient contact surface area therebetween, and consequently, is useful in the field of manufacturing wire harnesses for vehicles, and the like.

1. A connector terminal that is held by a housing into which an edge section of a circuit board provided with a connecting conductor provided on a surface of the edge section is inserted, and that constitutes a card edge type connector together with the housing, wherein the connector terminal includes:
a main body section having a board-contacting-surface which is falt and capable of making contact with the connecting conductor of the circuit board; and
an elastic deforming section which is positioned on a side opposite to the board-contacting-surface in a thickness direction of the circuit board, and which can deform elastically in the thickness direction with respect to the main body section.

2. A card edge type connector which is connected to a circuit board provided with a connecting conductor on a surface of an edge section thereof,
the card edge type connector comprising:
the connector terminal according to claim 1; and
a housing including a board inserting section into which the edge section of the circuit board can be inserted and a terminal accommodating chamber in which the connector terminal is accommodated in such a manner that the main body section is aligned in the thickness direction with respect to the circuit board that is inserted into the board inserting section, and the board-contacting-surface makes contact with the connecting conductor;
wherein the connector terminal is accommodated inside the terminal accommodating chamber in such a manner that, when the circuit board is inserted into the board inserting section, the main body section of the connector terminal is displaced towards an inner bottom surface side of the terminal accommodating chamber, with the elastic deforming section being deformed, and the board-contacting-surface of the main body section of the connector terminal makes pressure contact with the connecting conductor due to elastic force generated by the deformation of the elastic deforming section.

3. The card edge type connector according to claim 2,
wherein the elastic deforming section of the connector terminal has an abutting section which abuts against the inner bottom surface of the terminal accommodating chamber and receives a reactive force from the inner bottom surface; and
the board-contacting-surface and the abutting section of the connector terminal are aligned in the thickness direction of the circuit board,

4. The card edge type connector according to claim 2, wherein the connector terminal further comprises an elastic force reinforcing section which increases the elastic force of the elastic deforming section by deforming elastically together with the elastic deforming section with respect to the main body section.

5. The card edge type connector according to claim 2,
comprising a plurality of connector terminals as the connector terminal;
wherein the housing holds the plurality of connector terminals in such a manner that the connector terminals are respectively positioned on both the front and rear surfaces of the circuit board which is inserted into the board inserting section and the connector terminals are aligned in a direction along the edge section of the circuit board.
